(19) United States
(12) Patent Application Publication
(10) Pub. No.: US 2022/0194261 A1
(43) Pub. Date: Jun. 23, 2022

(54) METHOD AND SYSTEM FOR ACTIVATING AN ELECTRIC VEHICLE

(71) Applicant: TAIGA MOTORS INC., Lasalle (CA)

(72) Inventors: Samuel BRUNEAU, Montreal (CA); Gabriel BERNATCHEZ, Montreal (CA)

(21) Appl. No.: 17/552,968

(22) Filed: Dec. 16, 2021

Related U.S. Application Data
(60) Provisional application No. 63/129,210, filed on Dec. 22, 2020.

(51) Int. Cl. B60L 58/18; B60L 50/60; B60R 25/22

(52) U.S. Cl. CPC B60L 58/18; B60L 2210/10; B60R 25/225; B60L 50/60

(57) ABSTRACT

Systems and methods for activating electric vehicles and for reducing parasitic power draw from batteries of electric vehicles are provided. An electric system of an electric vehicle includes a main battery for powering an electric motor configured to propel the electric vehicle, an ancillary battery having a smaller size than the main battery, and a signal generator using power from the ancillary battery to generate a power-on signal to cause the electric vehicle to transition from the inactive state to an active state in response to a vehicle activation command. The main battery is electrically disconnected from any electric control units of the electric vehicle during an inactive state of the electric vehicle.

### CROSS REFERENCE TO RELATED APPLICATION AND CLAIM OF PRIORITY

The present application claims priority to U.S. provisional patent application No. 63/129,210 filed on Dec. 22, 2020, the entire contents of which are hereby incorporated herein by reference.

### TECHNICAL FIELD

The disclosure relates generally to electric vehicles, and more particularly to the utilization of battery power in electric vehicles.

### BACKGROUND

Vehicles typically leave some electrical components in standby mode to enable some functionality (e.g., unlocking doors) even when the vehicle is turned off. These electrical components represent potential electrical load paths even when the vehicle is off. The power draw in the off state of the vehicle is typically low and may be referred to as a “parasitic” power draw. Over an extended period of time, the parasitic draw may lead to depleting the vehicle's battery beyond a usable level.

It is common for some powersport vehicles to be used on a seasonal basis, and also be left inactive for extended periods of time such as during an off-season for example. During extended periods of inactivity, parasitic power draw on a battery of the powersport vehicle could result in the battery becoming depleted. Also, due to packaging, efficiency and weight considerations, it is preferable that batteries of powersport vehicles not be oversized. Improvement is desirable.

### SUMMARY

In one aspect, the disclosure describes an electric vehicle comprising:

an electric motor for propelling the electric vehicle;

a high-voltage (HV) battery for powering the electric motor when the electric motor is propelling the electric vehicle, the HV battery being electrically disconnected from any electronic control units of the electric vehicle during an inactive state of the electric vehicle;

a low-voltage (LV) battery having a lower voltage than the HV battery; and

a signal generator operatively connected to the LV battery to receive electric power from the LV battery, the signal generator using power from the LV battery to generate a power-on signal to cause the electric vehicle to transition from the inactive state to an active state in response to a vehicle activation command, at least one electronic control unit of the electric vehicle being electrically connected to the HV battery during the active state.

The signal generator may be a sole electric load powered by the LV battery when the vehicle is in the inactive state.

The HV battery may be electrically disconnected from any electric loads of the electric vehicle during the inactive state.

The signal generator may include a microcontroller for generating the power-on signal. The microcontroller may be powered by the LV battery.

The microcontroller may be operatively connected to an operator interface to receive the vehicle activation command from the operator interface. The operator interface may establish an electric connection between the microcontroller and the LV battery.

The operator interface may include a key establishing an operator's authorization to operate the electric vehicle, and a widget for receiving an operator input.

The microcontroller may be a sole electric load powered by the LV battery when the vehicle is in the inactive state.

The microcontroller may be a first microcontroller. The signal generator may include a second microcontroller operatively connected to the first microcontroller.

The second microcontroller may be configured to generate the vehicle activation command and cause the first microcontroller to generate the power-on signal.

The second microcontroller may be configured to: monitor for an operator's authorization to operate the electric vehicle; monitor for an operator input via a widget of an operator interface of the electric vehicle; and generate the vehicle activation command in response to the operator's authorization and to the operator input.

The second microcontroller may be powered by the LV battery.

The electric vehicle may comprise a DC/DC converter for reducing a voltage of power from the HV battery when the electric vehicle is in the active state, the DC/DC converter may be powered by the LV battery during the transition from the inactive state to the active state.

The at least one electronic control unit may be powered by the HV battery via the DC/DC converter during the active state.

Embodiments may include combinations of the above features.

In another aspect, the disclosure describes an electric system of an electric vehicle. The electric system may comprise:

a main battery pack for powering an electric motor configured to propel the electric vehicle, the main battery pack being electrically disconnected from any electric loads of the electric vehicle during an inactive state of the electric vehicle;

an ancillary battery having a smaller size than the main battery pack; and

a signal generator operatively connected to the ancillary battery to receive electric power from the ancillary battery, the signal generator using power from the ancillary battery to generate a power-on signal to cause the electric vehicle to transition from the inactive state to an active state in response to a vehicle activation command, the main battery pack being connected to one or more of the electric loads of the electric vehicle during the active state of the electric vehicle.

In a further aspect, the disclosure describes a method of activating an electric vehicle, the electric vehicle including a main battery for powering an electric motor configured to propel the electric vehicle, and an ancillary battery having a smaller size than the main battery. The method comprises:

when the electric vehicle is in an inactive state wherein the main battery is electrically disconnected from any electronic control units of the electric vehicle, receiving a vehicle activation command; and

in response to the vehicle activation command, using power from the ancillary battery to generate a power-on signal to cause the electric vehicle to transition from the inactive state to an active state, the main battery being connected to at least one electronic control unit of the electric vehicle during the active state of the electric vehicle.

The method may comprise, during the inactive state of the electric vehicle, using power from the ancillary battery to monitor for the vehicle activation command.

The method may comprise using a microcontroller powered by the ancillary battery to monitor for the vehicle activation command.

The microcontroller may be a sole electric load powered by the ancillary battery when the electric vehicle is in the inactive state.

The microcontroller may be a first microcontroller. The method may include using a second microcontroller in data communication with the first microcontroller to generate the activation command and cause the first microcontroller to generate the power-on signal.

The first microcontroller and the second microcontroller may be the only electric loads powered by the ancillary battery when the vehicle is in the inactive state.

The method may comprise, during the inactive state of the electric vehicle, using power from the ancillary battery to: monitor for an operator's authorization to operate the electric vehicle; monitor for an operator input via a widget of an operator interface of the electric vehicle; and generate the power-on signal in response to the operator's authorization to operate the electric vehicle and to the operator input.

Transitioning from the inactive state to the active state may include connecting the at least one electronic control unit to the main battery via a DC/DC converter powered by the ancillary battery.

The active state may be a wake state where the at least one electronic control unit of the electric vehicle is activated and the electric vehicle is prevented from being propelled by the electric motor.

The active state may be a ready state where the at least one electronic control unit of the electric vehicle is activated and the electric vehicle is permitted to be propelled by the electric motor.

The method may comprise using power from the main battery to charge the ancillary battery during the active state of the electric vehicle.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a schematic representation of an exemplary electric vehicle including a vehicle electric system as described herein;

FIG. 2 shows an exemplary key and start button associated with the electric vehicle of FIG. 1;

FIG. 3 is a flow diagram of an exemplary method of activating an electric vehicle;

FIG. 4A is a schematic diagram of an electric system of the electric vehicle of FIG. 1 when the electric vehicle is in an inactive state;

FIG. 4B is a schematic diagram of the electric system of FIG. 4 when the electric vehicle is in an active state;

FIG. 5 is a schematic diagram of an exemplary power-on signal generator of the electric system of FIG. 4;

FIG. 6 is a schematic diagram of another exemplary power-on signal generator of the electric system of FIG. 4; and

FIG. 7 is a flow diagram of an exemplary method of activating an electric vehicle.

### DETAILED DESCRIPTION

The following disclosure relates to electric systems of electric vehicles and associated methods. In some embodiments, the systems and methods described herein may be particularly suitable for electric powersport vehicles. Examples of suitable electric powersport vehicles include snowmobiles, motorcycles, personal watercraft (PWCs), all-terrain vehicles (ATVs), and (e.g., side-by-side) utility task vehicles (UTVs). In some embodiments, the systems and methods described herein may reduce or eliminate parasitic power draw on a main (motoring) battery pack of the electric vehicle during periods of inactivity. In some embodiments, the systems and methods described herein may make use of a relatively low-power circuit powered by an ancillary battery of the electric vehicle to monitor for a vehicle activation command. The low-power circuit may cause the electric vehicle to transition from an inactive state to an active (e.g., wake or ready) state after receiving the vehicle activation command.

The term “connected” may include both direct connection (in which two elements that are connected to each other contact each other) and indirect connection (in which at least one additional element is located between the two elements).

The term “substantially” as used herein may be applied to modify any quantitative representation which could permissibly vary without resulting in a change in the basic function to which it is related.

References made herein to “parasitic” power draw are intended to include unintentional drain on battery power which can be a function of electrical component losses/inefficiencies or indications of minor faults or maintenance issues. A parasitic power draw may be a relatively small leakage current that, over an extended period of time, may deplete a battery beyond its usable range. However, such parasitic power draw may not be significant enough to be apparent when the vehicle is operated frequently and the battery is also charged frequently.

Aspects of various embodiments are described through reference to the drawings.

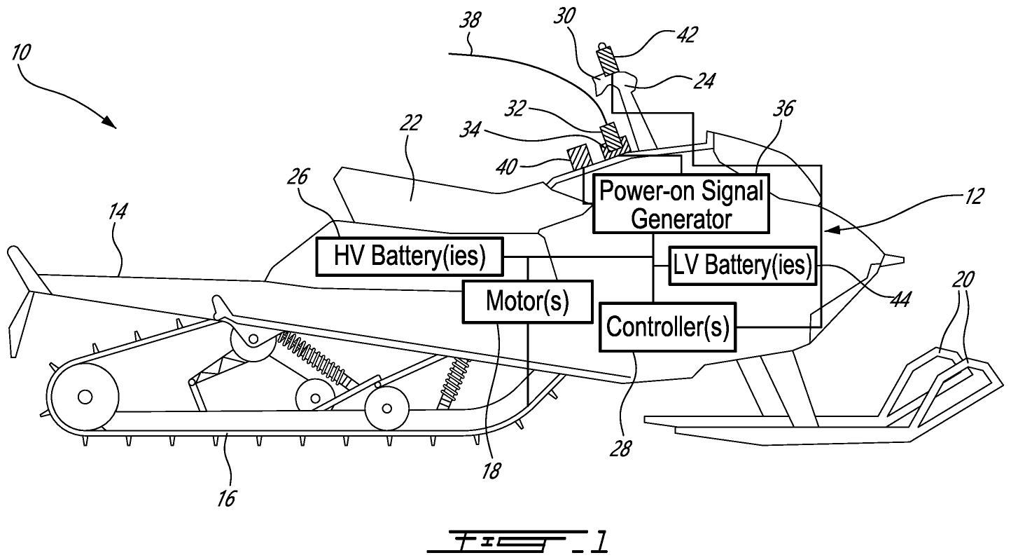

FIG. 1 is a schematic representation of an exemplary electric powersport vehicle 10 (referred hereinafter as “vehicle 10”) including electric system 12 (referred hereinafter as “system 12”) as described herein. As illustrated in FIG. 1, vehicle 10 may be a snowmobile but it is understood that the systems described herein may also be used on other types of electric vehicles such as electric UTVs, electric ATVs, electric PWCs, electric motorcycles, and other electric powersport vehicles. In some embodiments, vehicle 10 may be an electric snowmobile including elements of the snow vehicle described in International Patent Publication no. WO 2019/049109 A1 (Title: Battery arrangement for electric snow vehicles), and U.S. Patent Application No. 63/135,497 (Title: Electric vehicle with battery pack as structural element) which are incorporated herein by reference.

Vehicle 10 may include a frame (also known as a chassis) which may include tunnel 14, track 16 having the form of an endless belt for engaging the ground and disposed under tunnel 14, one or more electric motors 18 (referred hereinafter in the singular) mounted to the frame and configured to drive track 16, left and right skis 20 disposed in a front portion of vehicle 10, straddle seat 22 disposed above tunnel 14 for accommodating an operator of vehicle 10 and optionally one or more passengers (not shown). Skis 20 may be movably attached to the frame to permit steering of vehicle 10 via a steering assembly including a steering column interconnecting handlebar 24 with skis 20.

Motor 18 may be drivingly coupled to track 16 via a drive shaft. Electric motor 18 may be in torque-transmitting engagement with the drive shaft via a belt/pulley drive. However, motor 18 may be in torque-transmitting engagement with the drive shaft via other arrangements such as a chain/sprocket drive, or shaft/gear drive for example. The drive shaft may be drivingly coupled to track 16 via one or more toothed wheels or other means so as to transfer motive power from motor 18 to track 16. Motor 18 may have a power output rating of between 120 and 180 horsepower. Alternatively, motor 18 may have a maximum output power rating of greater than 180 horsepower. In some embodiments, multiple motors may be implemented to propel vehicle 10.

Vehicle 10 may also include one or more high-voltage (HV) batteries 26 (referred hereinafter in the singular) for providing electric power to motor 18 and driving motor 18 when vehicle 10 is being propelled by motor 18. HV battery 26 may be a main battery pack used for propelling vehicle 10. HV battery 26 may also be referred to as a motoring battery pack. HV battery 26 may be disposed under seat 22. The operation of motor 18 and the delivery of electric power to motor 18 may be controlled by controller 28 based on an actuation of accelerator 30, also referred to as “throttle”, by the operator. In some embodiments, HV battery 26 may be a rechargeable multi-cell lithium ion or other type of battery. HV battery 26 may include multiple battery modules each including multiple battery cells. The battery cells may be pouch cells, cylindrical cells and/or prismatic cells, for example. The battery modules may be housed within a battery enclosure for protection from impacts, water and/or debris. In some embodiments, HV battery 26 may be configured to output electric power at a voltage of between 300-400 volts, or up to 800 volts, for example.

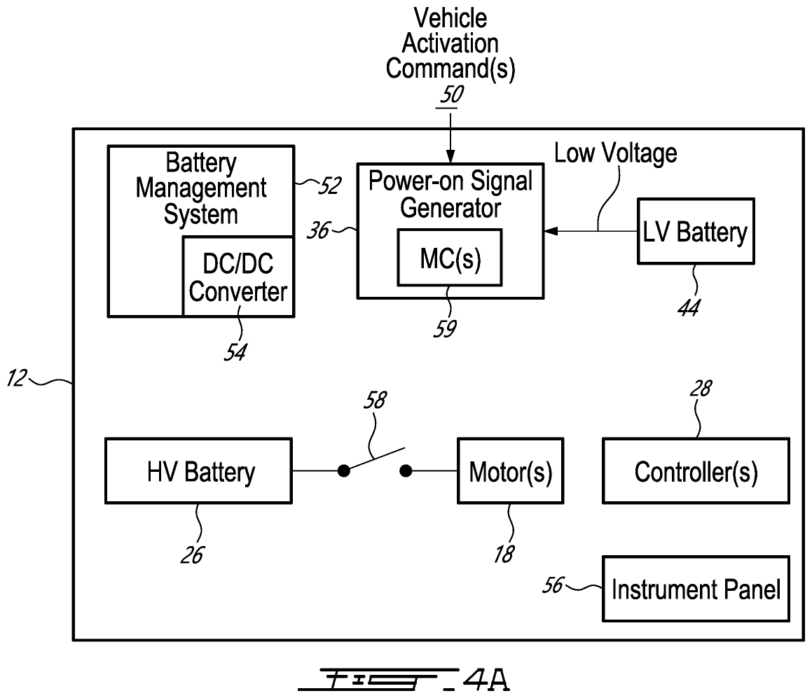

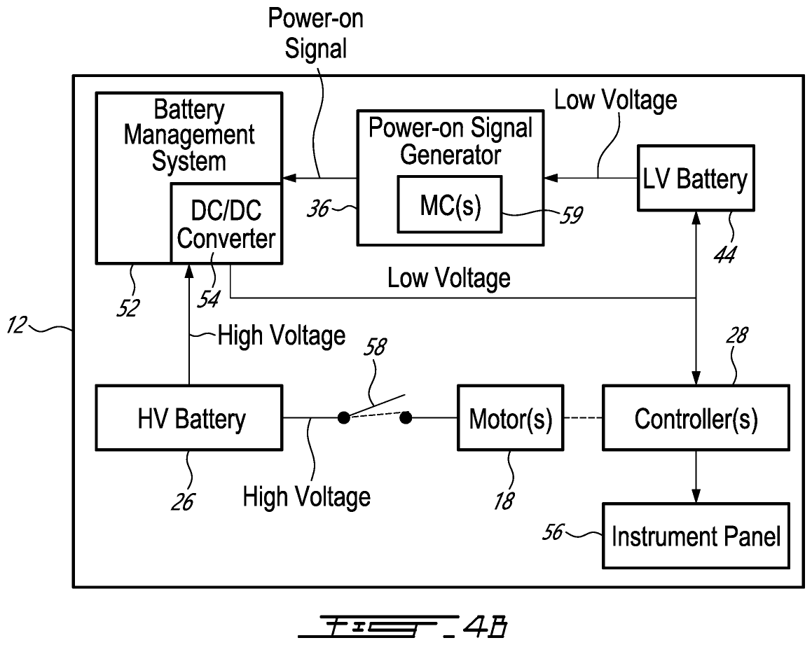

Vehicle 10 may include one or more controllers 28 (referred hereinafter in the singular) which may be of a type also known as an electronic control unit (ECU) or electronic control module (ECM) in some embodiments. Controller 28 may include a computer including one or more data processors and non-transitory machine-readable memory. Controller 28 may control, based on sensed and/or operator inputs, various aspects of vehicle 10. In some embodiments, controller 28 may include multiple ECUs that are dedicated to controlling different systems and subsystems of vehicle 10. Non-limiting examples of ECUs include a vehicle control unit, a motor control unit (which may also be referred to as a “power inverter”) and a battery control unit. Although controller 28 is illustrated as a single component of vehicle 10 in FIG. 1, the ECUs of controller 28 may be distributed at various locations within vehicle 10. For example, a motor control unit may be integrated as part of motor 18 and a battery control unit may be implemented by battery management system 52 (shown in FIG. 4A). An ECU may include one or more data processors and non-transitory machine-readable memory storing instructions that are executable by the data processors. Alternatively or additionally, an ECU may be implemented using an application specific integrated circuit (ASIC) and/or a field programmable gate array (FPGA).

In various embodiments, motor 18 may be a permanent magnet synchronous motor or a brushless direct current motor for example. Motor 18 may be of a same type as, or may include elements of, the motors described in U.S. Provisional Patent Application No. U.S. 63/135,466 (Title: Drive unit for electric vehicle) and U.S. Provisional Patent Application No. U.S. 63/135,474 (Title: Drive unit with fluid pathways for electric vehicle), which are both incorporated herein by reference.

Vehicle 10 may also include one or more brakes that may be applied or released by an actuation of a suitable brake actuator (e.g., lever) by the operator for example. In various embodiments, the brake(s) may include a friction-type brake including a master cylinder hydraulically connected to a brake caliper that urges bake pads against a brake rotor or disk that is coupled to a powertrain of vehicle 10. Actuation of the brake actuator (e.g., lever) may cause a combination of tractive braking and regenerative braking. Regenerative braking may also be applied in isolation, i.e., without tractive braking. In some embodiments, regenerative braking may be used such that HV battery 26 is supplied with electric energy generated by motor 18 operating as a generator when the brake actuator (e.g., lever) is applied, and/or when the operator releases accelerator 30.

In some embodiments, system 12 may include operator key 32 permitting the operation of vehicle 10 when key 32 is received into receptacle 34 of vehicle 10, or when key 32 is in sufficient proximity to vehicle 10 for example. The engagement of key 32 with receptacle 34 or the proximity of key 32 to vehicle 10 may be communicated to power-on signal generator 36 (referred hereinafter as “signal generator 36”) and/or to controller 28 (when controller 28 is activated) so that signal generator 36 and/or controller 28 may authorize the activation and/or operation of vehicle 10. Key 32 may be attached to one end of tether 38 (e.g., lanyard). The opposite end of tether 38 may be attached to the vehicle operator's clothing, belt, or (e.g., for watercraft use) personal flotation device during operation of vehicle 10. The presence of key 32 in receptacle 34 or in proximity to vehicle 10, and key 32 being valid, may indicate to system 12 that the operation of vehicle 10 is authorized.

Alternatively or in addition to the use of key 32, the presence of the operator in proximity to vehicle 10 and/or the authorization of the operator to operate vehicle 10 may be established by detecting the presence of a portable electronic device (PED) such as a smartphone that may be carried by the operator. Such PED may be in wireless data communication (e.g., paired via Bluetooth®) with controller 28 and/or with signal generator 36 to inform controller 28 and/or signal generator 36 of the proximity of the operator via the PED as a proxy. The use of key 32 and/or PED may be associated with an operator identification and permit an authentication of the operator to establish the operator's authorization to operate vehicle 10. Alternatively or in addition, the operator's authorization to operate vehicle 10 may be established by way of an authorization code or password that may be manually entered by the operator via an instrument panel of vehicle 10, or via a PED in communication with vehicle 10, permitting the operator to interact with and provide inputs to vehicle 10.

The operator interface of vehicle 10 may include one or more widgets for receiving input from the operator. Such widgets may, for example, include rotary switches, toggle switches, push buttons, knobs, dials, etc. The widgets may include one or more physical (hard) devices and/or one or more graphical objects on a graphical operator interface provided on a touch-sensitive display screen (e.g., instrument panel) of vehicle 10.

The operator interface of vehicle 10 may include start button 40 (e.g., a physical push button) or other input device(s) (e.g., rotary switch(es), multiple push buttons, receptacle 34 and key 32) suitable for generating one or more vehicle activation commands for transitioning vehicle 10 from an inactive (i.e., off) state to an active (e.g., wake or ready) state explained further below. Start button 40 may be disposed on or close to handlebar 24 or at another suitable location that is accessible by the operator. In some embodiments, a rotary switch (and optionally a key) may be suitable for generating a vehicle activation command for activating vehicle 10 after a period of inactivity. Such rotary switch may include different angular positions corresponding to the different states of vehicle 10 described herein.

The operator interface of vehicle 10 may include (e.g., emergency) shutoff switch 42, sometimes referred to as a “kill switch”, operatively connected to controller 28. Shutoff switch 42 may be disposed on or close to handlebar 24 or at another suitable location that is readily accessible by the operator when the operator is in the normal driving position. The actuation of shutoff switch 42 by the operator may provide the capability of stopping propulsion of vehicle 10 when vehicle 10 is in motion to, and/or cause vehicle 10 to transition from the active state to the inactive state.

As explained in more detail below, signal generator 36 may be a low-voltage and low-power-consumption circuit that causes vehicle 10 to transition from the inactive state to the active state in response to one or more vehicle activation commands. In various embodiments, signal generator 36 may be operatively connected to, or may include, start button 40 and/or receptacle 34 and/or key 32. In various embodiments, the vehicle activation command may originate onboard of vehicle 10 or remotely from vehicle 10. For example, the vehicle activation command may originate from a (e.g., onboard or remote) timer that is set (e.g., programmed) to cause activation of vehicle 10 at a predetermined time, or that may be set to intermittently cause activation of vehicle 10 at predetermined times. This timer may be implemented by signal generator 36 in some embodiments. The vehicle activation command may originate from a device configured to cause activation of vehicle 10 when vehicle 10 is connected to a charge station and HV battery 26 is being charged. The vehicle activation command may originate from a PED or other device that may be in wireless communication with vehicle 10.

Signal generator 36 may be operatively connected to low-voltage (LV) battery 44 to receive electric power from LV battery 44. Signal generator 36 may use power from LV battery 44 to generate a power-on signal to cause vehicle 10 to transition from the inactive to the active state. Signal generator 36 may be electrically isolated from HV battery 26 during the inactive state of vehicle 10 and be powered by LV battery 44 only. LV battery 44 may have a lower voltage than HV battery 26. LV battery 44 may have a smaller physical size and weight than HV battery 26 and may be considered an ancillary battery used to power auxiliary systems or devices of vehicle 10 but not used directly for propulsion of vehicle 10. LV battery 44 may have a smaller energy storage capacity than HV battery 26 because of its smaller size and weight. In some embodiments, LV battery 44 may be configured to output electric power at a voltage of 12 volts for example. In various embodiments, LV battery 44 may be a rechargeable lithium-ion, lead-acid, or other type of rechargeable battery.

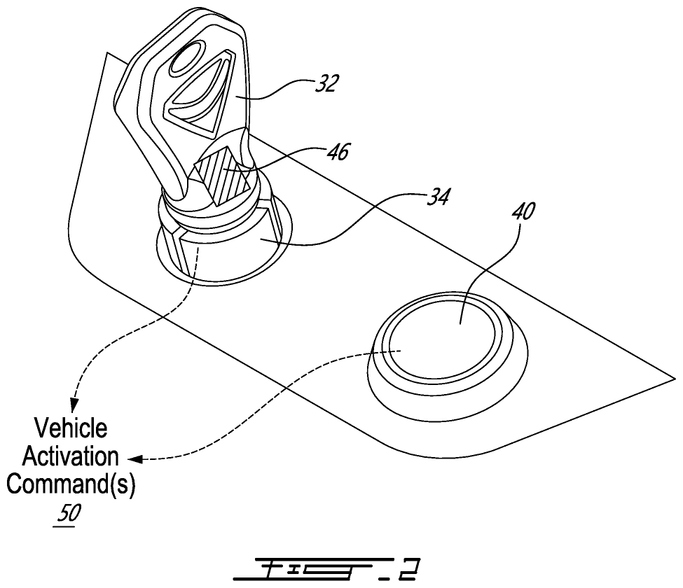

FIG. 2 shows an exemplary representation of key 32 and of start button 40 associated with vehicle 10. In some embodiments, key 32 may be part of a radio-frequency identification (RFID) system of vehicle 10. Key 32 may include RFID tag 46 which may store data identifying key 32 or a specific operator associated with key 32. When triggered by an electromagnetic interrogation pulse from a RFID reader device associated with vehicle 10, RFID tag 46 may wirelessly transmit the data stored on RFID tag 46 and the data may be used by signal generator 36 and/or controller 28 to authenticate key 32 and either permit or prevent the operation of vehicle 10 based on the data. In some embodiments, key 32 may interact with a first software-based or physical/mechanical hardware-based switch disposed within receptacle 34 so that the insertion and withdrawal of key 32 into and out of receptacle 34 may cause key 32 to interface with and actuate such switch, and signal to signal generator 36 and/or controller 28 the operator's authorization to use vehicle 10. In some embodiments, vehicle 10 may include a (e.g., rotary) switch that is actuatable with key 32.

Start button 40 may be disposed in proximity to receptacle 34. Start button 40 may be operatively connected to signal generator 36 and may be used to generate one or more vehicle activation commands 50 that may be received at signal generator 36 and cause signal generator 36 to generate a suitable power-on signal for transitioning vehicle 10 from the inactive state to the active state.

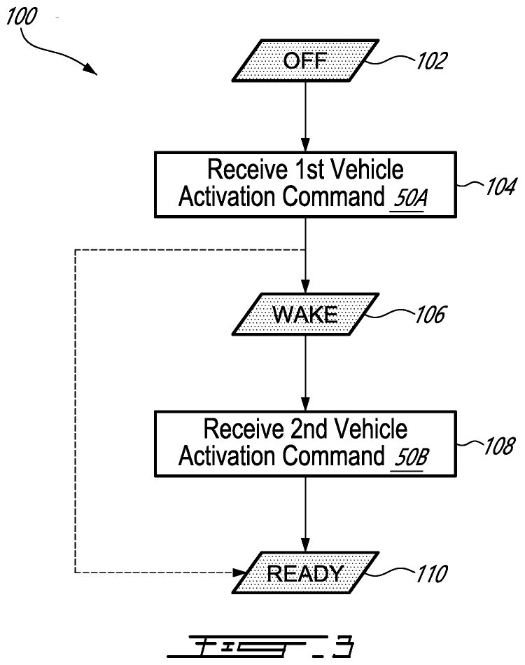

FIG. 3 is a flow diagram of an exemplary method 100 of activating vehicle 10, or another electric (e.g., powersport) vehicle. Aspects of method 100 may be combined with other actions or aspects of other methods described herein. Aspects of vehicles described herein may also be incorporated into method 100. In some embodiments, the activation or start-up of vehicle 10 may include transitioning vehicle 10 from an inactive (i.e., off) state directly to a fully active (i.e., ready) state in a single step based on one or more vehicle activation commands 50. The fully active state may enable all systems of vehicle 10 for an operator, including the activation of one or more displays, and the use of accelerator 30 to deliver power to motor 18 and propel vehicle 10 being permitted. The fully active state of vehicle 10 may also be referred to as an “in gear” state.

In some embodiments, the activation or start-up of vehicle 10 may include transitioning vehicle 10 from the inactive (i.e., off) state to an intermediate partially active (i.e., wake) state, and then to a fully active (i.e., ready) state. The partially active state may enable some systems of vehicle 10, such as turning on a display of vehicle 10, but may restrict (e.g., prevent) the use of accelerator 30 to deliver power to motor 18 and propel vehicle 10. For example, method 100 may make use of a two-step approach for transitioning vehicle 10 from the inactive state to the ready state where vehicle 10 may be propelled. In various embodiments, the two steps may include two vehicle activation commands 50 received via a common operator input device such as start button 40 for example. Alternatively, the two vehicle activation commands 50 may be received via different operator input devices.

In various embodiments, method 100 may include:

when vehicle 10 is in the inactive (off) state (block 102), first vehicle activation command 50A may be received (block 104);

in response to first vehicle activation command 50A, vehicle 10 may be transitioned from the off state to the wake state (block 106);

after receiving first vehicle activation command 50A, second vehicle activation command 50B may be received (block 108); and

in response to second vehicle activation command 50B, vehicle 10 may be transitioned from the wake state to the ready state (block 110).

In some embodiments, method 100 may include, in response to first vehicle activation command 50A, transitioning vehicle 10 from the off state directly to the ready state as shown by the broken line extending directly between block 104 and block 110.

In some embodiments, method 100 may optionally include transitioning vehicle 10 from the ready state to the wake state, from the wake state to the off, and/or from the ready state to the off state in response to one or more other commands such as a shut-off command received via shut-off switch 42 for example, or a further actuation of start button 40 for example. Further aspects of method 100 are described below in reference to FIGS. 4A and 4B.

FIG. 4A is a schematic diagram of electric system 12 of vehicle 10 when vehicle 10 is the inactive state and is monitoring for vehicle activation command(s) 50. FIG. 4B is a schematic diagram of electric system 12 of vehicle 10 when vehicle 10 is the active (e.g., wake) state. System 12 may include battery management system 52 (referred hereinafter as “BMS 52”) that manages the operation of HV battery 26 by, for example, protecting HV battery 26 from operating outside its safe operating regime, monitoring the state of HV battery 26, and/or balancing HV battery 26. BMS 52 may include direct current (DC) to direct current (DC) converter 54 (referred hereinafter as “DC/DC converter 54”). DC/DC converter 54 may be an electronic circuit or electromechanical device including switches (e.g., transistors) that converts direct current from HV battery 26 from a higher voltage to a lower voltage. As shown in FIG. 4B, direct current from HV battery 26 may be converted to a lower voltage (e.g., 12 volts) and used to power controller 28, instrument panel 56, and to charge LV battery 44.

The operation of motor 18 and the delivery of high-voltage alternating current (AC) or DC electric power from HV battery 26 to motor 18 may be controlled by controller 28 via a suitable motor control unit or other power electronics module (not shown) including electronic switches (e.g., insulated gate bipolar transistor(s)) to provide motor 18 with electric power having the desired voltage, current, waveform, etc. to implement the desired performance of vehicle 10 based on an actuation of accelerator 30 by the operator. In some embodiments, controller 28 includes a power inverter to control the delivery of AC power to motor 18.

In the inactive state shown in FIG. 4A, BMS 52, DC/DC converter 54 motor 18, controller 28, instrument panel 56, and other devices/accessories of vehicle 10 may be turned off and not supplied with power. Even though the elements of system 12 may be physically integrated into vehicle 10, the lack of connections between elements of system 12 shown in FIG. 4A indicates that no electric power is being transmitted between those components. For example, HV battery 26 may be electrically disconnected from any electric loads (e.g. electronic control units) of vehicle 10 when vehicle 10 is in the inactive state. Disconnecting HV battery 26 from any (all) electric loads (i.e., including signal generator 36 and controller 28) may reduce the risk of parasitic power draw from HV battery 26 during periods of inactivity. Disconnecting HV battery 26 from low voltage electric loads may be achieved by deactivating DC/DC converter 54 and/or by opening a contactor (not shown) operatively disposed between HV battery 26 and DC/DC converter 54. Disconnecting HV battery 26 from motor 18 may be achieved by controller 28 and a power electronic module being in an off state, and/or by opening contactor 58 operatively disposed between HV battery 26 and motor 18. In some embodiments, contactor 58 may be integrated with motor 18. Alternatively or additionally, contactor 58 may be implemented by a power inverter.

It should be noted that disconnecting a battery from electric loads may include disconnecting the battery from any electronic devices, modules or control units that may, intentionally or unintentionally, draw power from the battery. For example, if the battery is electrically connected to an electronic control unit to power the electronic control unit, parasitic power draw from the battery may occur at the electronic control unit even when it is in standby mode and not performing any operations. By disconnecting the battery from the electronic control unit, this source of parasitic draw may be eliminated and the overall parasitic draw from the battery may be reduced. In this way, reducing the number of loads electrically connected to the battery may reduce the parasitic draw from the battery. However, disconnecting a battery from any electric loads (e.g. electronic control units) does not necessarily mean that zero current is being drawn from the battery. Small amounts of current may still drain from the battery due to unavoidable current leakage even when disconnected from electric loads. Consider, by way of example, HV battery 26 shown in FIG. 4A which is disconnected from other components of system 12. As noted above, this is an example of HV battery 26 being disconnected from any electric loads of system 12. Small leakage currents, which may be due to imperfections or faults in system 12, may still exist and drain current from HV battery 26.

Vehicle 10 may be placed in the inactive state in preparation for a period of inactivity of vehicle 10, and/or when vehicle 10 is to be left unattended for example. In some embodiments, signal generator 36 may be the only (sole) electric load of vehicle 10 that consumes power when vehicle 10 is in the inactive state. As explained below, signal generator 36 may be powered by LV battery 44 and may consume a relatively low amount of power. In some embodiments, signal generator 36 may include one or more microcontrollers 59 (referred hereinafter as “MC 59”) or other type(s) of data processor (e.g., ASIC or FPGA). MC 59 may include one or more processing units along with memory and programmable input/output peripherals. MC 59 may operate at relatively low power consumption and may be powered by LV battery 44 when vehicle 10 is in the inactive state. As shown in FIG. 4A, MC 59 may be a sole electric load powered by LV battery 44 when vehicle 10 is in the inactive state. MC 59 may have the ability to retain functionality while waiting for one or more events such as vehicle activation command 50 via a press of start button 40 and/or a presence of key 32 in receptacle 34 or in proximity to vehicle 10 for example.

In reference to FIG. 4B, the receipt of vehicle activation command 50 may cause signal generator 36 to generate the power-on signal that may be transmitted to BMS 52 to initiate the transition of vehicle 10 from the inactive to the active state. In some embodiments, the power-on signal may be a digital signal that is transmitted to BMS 52 via a suitable controller area network (CAN bus) or other type of data bus. In response to the power-on signal, DC/DC converter 54 may be activated to convert high voltage power from HV battery 26 to low voltage power suitable for powering various components of vehicle 10. The operation of DC/DC converter 54 may be powered by LV battery 44 at least during the transition to the active state. When vehicle 10 is in the active state, DC/DC converter 54 may be powered by its own low voltage output. Alternatively, when vehicle 10 is in the active state, DC/DC converter 54 may still be powered by LV battery 44.

As shown in FIG. 4B, the low voltage power delivered from DC/DC converter 54 may be used to power controller 28 and instrument panel 56 when vehicle 10 is in the active state. The low voltage power delivered from DC/DC converter 54 may also be used to charge LV battery 44 as LV battery 44 is powering DC/DC converter 54. In this way, HV battery 26 may be electrically connected to controller 28, instrument panel 56 and/or LV battery 44 via DC/DC converter 54 when in the active state.

The active state of vehicle 10 illustrated in FIG. 4B is the wake state in which operator interaction with vehicle 10 via instrument panel 56, for example, may be permitted. For example, an operator may interact with instrument panel 56 or other operator interface of vehicle 10 to select an operation mode (e.g., economy, normal, sport) for vehicle 10 and/or adjust other vehicle settings. In the wake state, one or more preparatory tasks may be carried out in preparation for the driving of vehicle 10 but propulsion of vehicle 10 via motor 18 may be prevented. Contactor 58 may be open as shown in FIG. 4B, or alternatively may be closed. However, propulsion commands received via accelerator 30 may be ignored by controller 28 when vehicle 10 is in the wake state. A visual or other type of indication may be provided to the operator (e.g., via instrument panel 56) to indicate the wake state of vehicle 10.

In some embodiments, the active state of vehicle 10 may be the ready state in which, in addition to the wake state, propulsion of vehicle 10 via motor 18 may be permitted. In reference to FIG. 4B, the ready state of vehicle 10 may be reached by the closing of contactor 58 as shown by the broken line of contactor 58, and/or controller 28 being ready to control the operation of motor 18 according to propulsion commands received via accelerator 30 as shown by the broken line extending between controller 28 and motor 18. A visual or other type of indication may be provided to the operator (e.g., via instrument panel 56) to indicate the ready state of vehicle 10.

In some embodiments, the transition of vehicle 10 from the inactive state to the active state may not require an operator's authorization to operate vehicle 10 being received via key 32 or otherwise. However, in some embodiments, the transition of vehicle 10 from the inactive state to the active state may be conditioned upon the operator's authorization to operate vehicle 10 having been received. For example, a transition from the off state to the wake state may be permitted with only a press of start button 40. However, a transition from the off or wake state to the ready state may additionally require the operator's authorization via key 32 or otherwise.

In some embodiments, the transition of vehicle 10 from the active state to the inactive state may occur automatically if vehicle 10 is left in either the wake state or the ready state without interaction for a time period that exceeds a prescribed threshold for example. For example, vehicle 10 may be automatically transitioned from the ready state to the wake state (or to the off state) in the absence of an input to accelerator 30 within a predetermined duration. In some embodiments, vehicle 10 may be transitioned from the active state to the inactive state by the removal of key 32 from receptacle 34. In some embodiments, vehicle 10 may be transitioned from the active state to the inactive state manually by a subsequent (e.g., and longer—a few seconds) press of start button 40 for example.

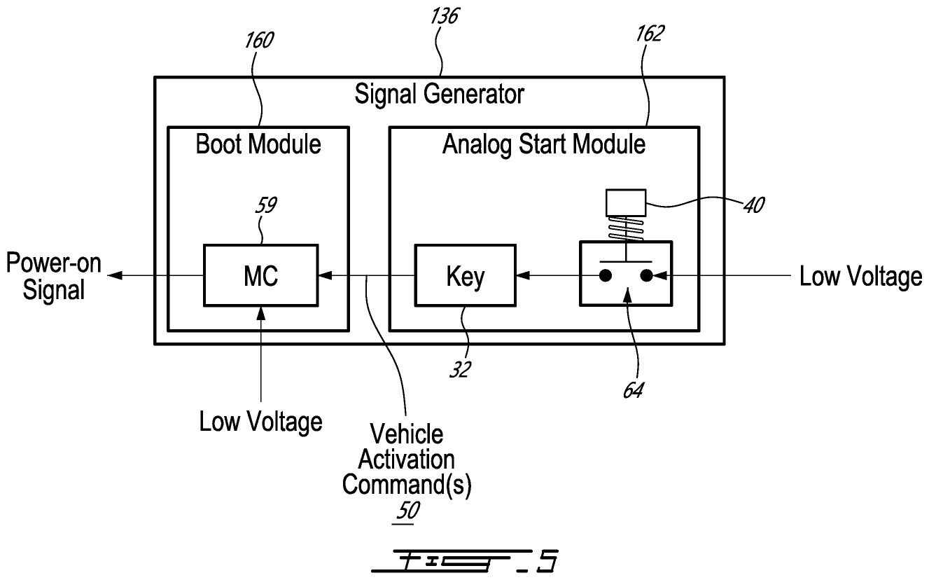

FIG. 5 is a schematic diagram of another exemplary power-on signal generator 136 (referred hereinafter as “signal generator 136”) that may be incorporated into system 12 of vehicle 10. Signal generator 136 may include elements previously described and like elements are identified using like reference numerals. Signal generator 136 may include boot module 160 operatively connected to analog start module 162. Boot module 160 may include MC 59 configured to monitor for the receipt of vehicle activation command 50. However, boot module 160 may instead have an analog implementation. In response to vehicle activation command 50, MC 59 may output the digital power-on signal to cause the transition of vehicle 10 from the inactive state to the active state. The single MC 59 may be the sole electric load powered by LV battery 44 when vehicle 10 is in the inactive state.

Vehicle activation command 50 may include a change from a lower voltage (e.g., zero volt) to a higher voltage (e.g., 12 volts) sensed at MC 59. Vehicle activation command 50 may be generated by analog start module 162, which may be separate from or part of signal generator 136. Analog start module 162 may function to establish an electrical connection between MC 59 and LV battery 44 when one or more conditions are met. For example, switch 64 may be operatively disposed between LV battery 44 and boot module 160. Switch 64 may be biased toward a normally-open configuration and may be actuatable by the operator via start button 40 or other widget with which the operator may interact (e.g., manipulate, actuate) to provide an operator input. For example, start button 40 may be spring-loaded so that the momentary pressing of start button 40 may cause momentary closing of switch 64 to provide electric communication across switch 64.

In some embodiments, the presence of key 32 in receptacle 34 may be another condition to be met in order to generate vehicle activation command 50. The presence of key 32 in receptacle 34 may cause the closing of another switch (not shown) to establish electric communication between LV battery 44 and boot module 160. Alternatively, electric communication may be established across key 32 when key 32 is received in receptacle 34. Together, the presence of key 32 in receptacle 34 and the closing of switch 64 may provide an electric connection between LV battery 44 and MC 59 of boot module 160.

The power-on signal generated by boot module 160 may initiate the operation of DC/DC converter 54. In some embodiments, MC 59 may also monitor the initiation of DC/DC converter 54 and may implement a timeout criterion where the power-on signal is discontinued if DC/DC converter 54 did not start properly within a threshold time period. Discontinuing the power-on signal may cease the initiation of DC/DC converter 54. In such situation, the transition of vehicle 10 to the active state may be aborted and a suitable annunciation may optionally be provided to the operator. In such situation, boot module 160 may then continue or resume monitoring for vehicle activation command 50.

Instead of, or in addition to start button 40 and key 32, one or more other (e.g., proximity) sensors, switches, relays, timers, and/or other devices may be included in analog start module 162 to implement various conditions to be met before issuing vehicle activation command 50 to boot module 160. The transition of vehicle 10 from the inactive state to the active state may be prevented if the applicable conditions are not met.

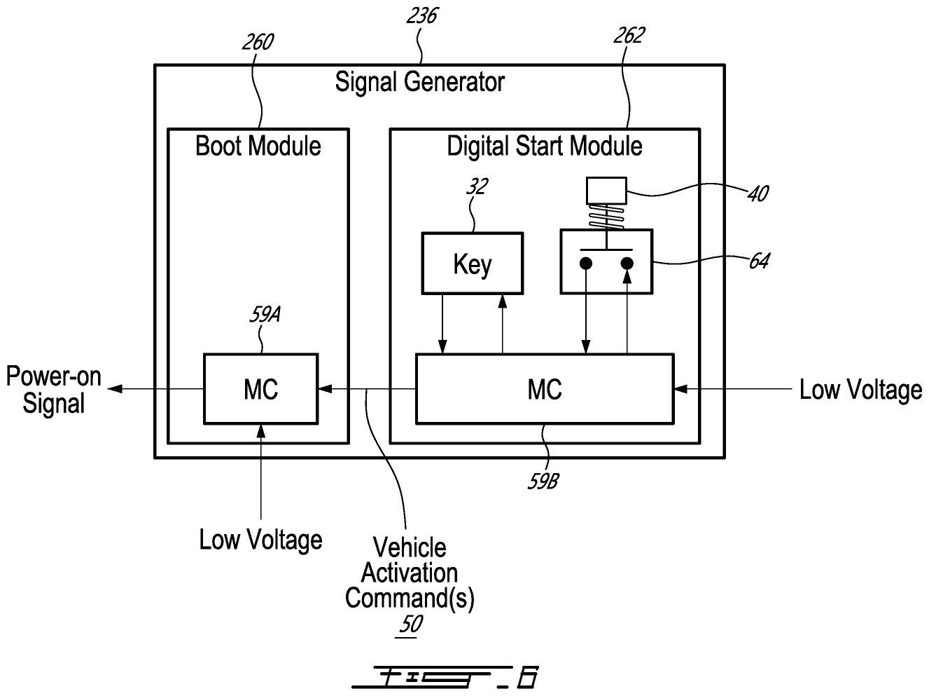

FIG. 6 is a schematic diagram of another exemplary power-on signal generator 236 (referred hereinafter as “signal generator 236”) that may be incorporated into system 12 of vehicle 10. Signal generator 236 may include elements previously described and like elements are identified using like reference numerals. Signal generator 236 may include boot module 260 operatively connected to digital start module 262. Boot module 260 may include first MC 59A configured to monitor for the receipt of vehicle activation command 50. In response to vehicle activation command 50, first MC 59 may output the digital power-on signal to cause the transition of vehicle 10 from the inactive state to the active state. First MC 59A may be powered by LV battery 44 when vehicle 10 is in the inactive state.

Vehicle activation command 50 may include a digital signal transmitted to first MC 59A via a data bus (e.g., CAN bus) for example. Vehicle activation command 50 may be generated by digital start module 262, which may be separate from or part of signal generator 236. Digital start module 262 may function to generate vehicle activation command 50 in digital form when one or more conditions are met. For example, digital start module 262 may include second MC 59B in data communication with first MC 59A of boot module 260. Second MC 59B may be configured to monitor for one or more conditions such as operator's authorization to operate vehicle 10 and/or an operator input received via a widget of the operator interface of vehicle 10, and generate the vehicle activation command 50 in digital form in response to the conditions being met. For example, second MC 59B may be configured to monitor for the pressing of start button 40 and/or the presence of key 32 in receptacle 34.

Instead of, or in addition to start button 40 and key 32, second MC 59B may monitor for other conditions to implement various conditions to be met before issuing vehicle activation command 50. Such other conditions may include the proximity of key 32 to vehicle 10, the pairing of an operator's PED with vehicle 10, and/or the receipt of a wireless signal indicative of a request to start vehicle 10 from an authorized or recognized communication device. In some embodiments, second MC 59B may implement a timer to issue vehicle activation command 50 at a predetermined time and/or intermittently. Powering-on an electric vehicle intermittently may allow a low voltage battery to be charged during long periods of inactivity (e.g., during an off-season for an electric powersports vehicle).

Second MC 59B may be powered by LV battery 44. In some embodiments, first MC 59A and second MC 59B may be the only electrical loads that are powered by LV battery 44 when vehicle 10 is in the inactive state.

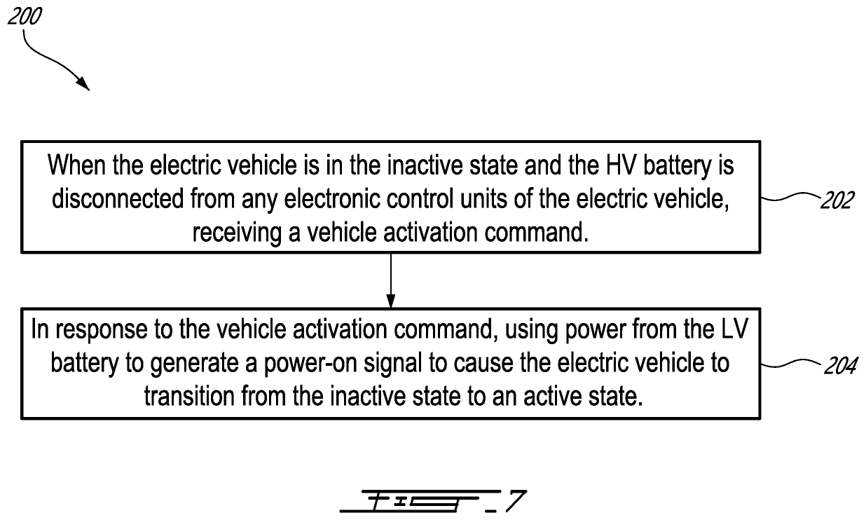

FIG. 7 is a flow diagram of another exemplary method 200 of activating vehicle 10, or another electric (e.g., powersport) vehicle. Aspects of method 200 may be combined with other actions or aspects of other methods described herein. Aspects of vehicles described herein may also be incorporated into method 200. In various embodiments, method 200 may include:

when vehicle 10 is in the inactive state and HV battery 26 is disconnected from any electronic control units of vehicle 10, receiving vehicle activation command 50 (block 202); and

in response to vehicle activation command 50, using power from LV battery 44 to generate the power-on signal to cause vehicle 10 to transition from the inactive state to the active state (block 204).

In some embodiments of method 200, the transition from the inactive state to the active state may cause HV battery 26 to become electrically connected to and supply power to one or more electric loads (e.g., electronic control units) of vehicle 10 during the active state of vehicle 10.

Method 200 may include, during the inactive state of vehicle 10, use power from LV battery 44 to monitor for the receipt of vehicle activation command 50. Monitoring for the receipt of vehicle activation command 50 may be performed using MC 59 or first MC 59A powered by LV battery 44.

Transitioning from the inactive state to the active state may include connecting the one or more electric loads (e.g., electronic control units) to HV battery 26 via DC/DC converter 54 powered by LV battery 44.

In some embodiments of method 200, the active state may be a wake state where controller 28 is activated but vehicle 10 is prevented from being propelled by motor 18. Alternatively, the active state may be a ready state in which controller 28 may be activated and vehicle 10 may be propelled by motor 18.

Method 200 may include, during the inactive state of vehicle 10, using power from LV battery 44 to: monitor for an operator's authorization to operate vehicle 10 (e.g., via key 32); monitor for an operator input via a widget (e.g., start button 40) of an operator interface of vehicle 10; and generate the power-on signal in response to the operator's authorization to operate vehicle 10 and to the operator input.

In some embodiments of method 200, transitioning from the inactive state to the active state may include connecting one or more electric loads to HV battery via DC/DC converter 54 powered by LV battery 44.

Method 200 may include using power from HV battery 26 to charge LV battery 44 during the active sate of vehicle 10 when LV battery 44 is powering DC/DC converter 54 for example.

The embodiments described in this document provide non-limiting examples of possible implementations of the present technology. Upon review of the present disclosure, a person of ordinary skill in the art will recognize that changes may be made to the embodiments described herein without departing from the scope of the present technology.

What is claimed is:

1. An electric vehicle comprising:
an electric motor for propelling the electric vehicle;
a high-voltage (HV) battery for powering the electric motor when the electric motor is propelling the electric vehicle, the HV battery being electrically disconnected from any electronic control units of the electric vehicle during an inactive state of the electric vehicle;
a low-voltage (LV) battery having a lower voltage than the HV battery; and
a signal generator operatively connected to the LV battery to receive electric power from the LV battery, the signal generator using power from the LV battery to generate a power-on signal to cause the electric vehicle to transition from the inactive state to an active state in response to a vehicle activation command, at least one electronic control unit of the electric vehicle being electrically connected to the HV battery during the active state.

2. The electric vehicle as defined in claim 1, wherein the signal generator is a sole electric load powered by the LV battery when the vehicle is in the inactive state.

3. The electric vehicle as defined in claim 1, wherein the HV battery is electrically disconnected from any electric loads of the electric vehicle during the inactive state.

4. The electric vehicle as defined in claim 1, wherein the signal generator includes a microcontroller for generating the power-on signal, the microcontroller being powered by the LV battery.

5. The electric vehicle as defined in claim 4, wherein:
the microcontroller is operatively connected to an operator interface to receive the vehicle activation command from the operator interface; and
the operator interface establishes an electric connection between the microcontroller and the LV battery.

6. The electric vehicle as defined in claim 5, wherein the operator interface includes a key establishing an operator's authorization to operate the electric vehicle, and a widget for receiving an operator input.

7. The electric vehicle as defined in claim 4, wherein the microcontroller is a sole electric load powered by the LV battery when the vehicle is in the inactive state.

8. The electric vehicle as defined in claim 4, wherein:
the microcontroller is a first microcontroller;
the signal generator includes a second microcontroller operatively connected to the first microcontroller; and
the second microcontroller is configured to generate the vehicle activation command and cause the first microcontroller to generate the power-on signal.

9. The electric vehicle as defined in claim 8, wherein the second microcontroller is configured to:
monitor for an operator's authorization to operate the electric vehicle;
monitor for an operator input via a widget of an operator interface of the electric vehicle; and
generate the vehicle activation command in response to the operator's authorization and to the operator input.

10. The electric vehicle as defined in claim 8, wherein the second microcontroller is powered by the LV battery.

11. The electric vehicle as defined in claim 1, comprising a DC/DC converter for reducing a voltage of power from the HV battery when the electric vehicle is in the active state, the DC/DC converter being powered by the LV battery during the transition from the inactive state to the active state.

12. The electric vehicle as defined in claim 11, wherein the at least one electronic control unit is powered by the HV battery via the DC/DC converter during the active state.

13. An electric system of an electric vehicle, the electric system comprising:
a main battery pack for powering an electric motor configured to propel the electric vehicle, the main battery pack being electrically disconnected from any electric loads of the electric vehicle during an inactive state of the electric vehicle;
an ancillary battery having a smaller size than the main battery pack; and
a signal generator operatively connected to the ancillary battery to receive electric power from the ancillary battery, the signal generator using power from the ancillary battery to generate a power-on signal to cause the electric vehicle to transition from the inactive state to an active state in response to a vehicle activation command, the main battery pack being connected to one or more of the electric loads of the electric vehicle during the active state of the electric vehicle.

14. A method of activating an electric vehicle, the electric vehicle including a main battery for powering an electric motor configured to propel the electric vehicle, and an ancillary battery having a smaller size than the main battery, the method comprising:
when the electric vehicle is in an inactive state wherein the main battery is electrically disconnected from any electronic control units of the electric vehicle, receiving a vehicle activation command; and
in response to the vehicle activation command, using power from the ancillary battery to generate a power-on signal to cause the electric vehicle to transition from the inactive state to an active state, the main battery being connected to at least one electronic control unit of the electric vehicle during the active state of the electric vehicle.

15. The method as defined in claim 14, comprising, during the inactive state of the electric vehicle, using power from the ancillary battery to monitor for the vehicle activation command.

16. The method as defined in claim 14, comprising using a microcontroller powered by the ancillary battery to monitor for the vehicle activation command.

17. The method as defined in claim 16, wherein the microcontroller is a sole electric load powered by the ancillary battery when the electric vehicle is in the inactive state.

18. The method as defined in claim 16, wherein:
the microcontroller is a first microcontroller; and
the method includes using a second microcontroller in data communication with the first microcontroller to generate the activation command and cause the first microcontroller to generate the power-on signal.

19. The method as defined in claim 18, wherein the first microcontroller and the second microcontroller are the only electric loads powered by the ancillary battery when the vehicle is in the inactive state.

20. The method as defined in claim 14, comprising, during the inactive state of the electric vehicle, using power from the ancillary battery to:
monitor for an operator's authorization to operate the electric vehicle;
monitor for an operator input via a widget of an operator interface of the electric vehicle; and
generate the power-on signal in response to the operator's authorization to operate the electric vehicle and to the operator input.

21. The method as defined in claim 14, wherein transitioning from the inactive state to the active state includes connecting the at least one electronic control unit to the main battery via a DC/DC converter powered by the ancillary battery.

22. The method as defined in claim 14, wherein the active state is a wake state where the at least one electronic control unit of the electric vehicle is activated and the electric vehicle is prevented from being propelled by the electric motor.

23. The method as defined in claim 14, wherein the active state is a ready state where the at least one electronic control unit of the electric vehicle is activated and the electric vehicle is permitted to be propelled by the electric motor.

24. The method as defined in claim 14, comprising using power from the main battery to charge the ancillary battery during the active state of the electric vehicle.
